(19) United States
(12) Patent Application Publication
(10) Pub. No.: US 2021/0141627 A1
(43) Pub. Date: May 13, 2021

(54) POWER DELIVERY CONTROLLER UPDATES

(71) Applicant: Hewlett-Packard Development Company, L.P., Spring, TX (US)

(72) Inventors: Yi-Fan Hsia, New Taipei City (TW); Po Chin Chung, Keelung City (TW); Hung Lung Chen, Taipei City (TW)

(21) Appl. No.: 16/682,881

(22) Filed: Nov. 13, 2019

(51) Int. Cl. G06F 8/65

(52) U.S. Cl. CPC G06F 8/65

(57) ABSTRACT

Examples of methods for updating power delivery controllers are described herein. In some examples, a method may include updating a power delivery controller. In some examples, the power delivery controller may be updated using power delivery controller instructions from interface memory. In some examples, the power delivery controller may be updated in response to an apparatus shutdown.

### BACKGROUND

The use of electronic devices has expanded. Computing devices are a kind of electronic device that includes electronic circuitry for performing processing. As processing capabilities have expanded, computing devices have been utilized to perform more functions. For example, a variety of computing devices are used for work, communication, and entertainment. Computing devices may be linked to other devices and may communicate with other devices.

### BRIEF DESCRIPTION OF THE DRAWINGS

FIG. 1 is a flow diagram illustrating an example of a method for updating a power delivery controller;

FIG. 2 is a flow diagram illustrating an example of a method for updating a power delivery controller;

FIG. 3 is a block diagram of an example of an apparatus that may be used in updating a power delivery controller; and

FIG. 4 is a thread diagram illustrating an example of updating a power delivery controller.

### DETAILED DESCRIPTION

Computing devices consume electrical power to operate. For example, computing devices may be powered by a power source such as an electrical grid (e.g., plugged into a wall outlet) or a battery. Some computing devices do not include a battery. For instance, some desktop computers, game consoles, smart appliances, etc., may not include a battery and/or may be powered via an interface. An interface is a device to interface with another device. An interface may include connector hardware (e.g., a port, a plug, a connector, a controller, circuitry, etc.) and instructions for operating the connector hardware. In some examples, an interface may include a connection or connections (e.g., wire(s), cable(s), etc.). An example of an interface that may provide power is a Universal Serial Bus (USB) interface (e.g., USB-C interface, USB Type-C, etc.). For instance, a computing device may include an interface and/or may be connected to an interface to provide power to the computing device.

Some interfaces include a power delivery controller. A power delivery controller is circuitry that controls power delivery through an interface. In some examples, a power delivery controller may include power delivery controller instructions and/or may execute power delivery controller instructions to perform power delivery functions. Power delivery controller instructions are instructions for performing a power delivery operation or operations. For example, a power delivery controller of an interface may execute power delivery controller instructions to negotiate with a power delivery controller of a connected interface to establish voltage, amperage, and/or wattage for power delivery.

In some approaches, an interface may disconnect from a power source when updating power delivery controller instructions. Disconnecting a power source while updating may be disruptive. For example, disconnecting a desktop computer from a power source for a power controller instruction update may abruptly disable the desktop computer. For instance, the disconnection may cause disruption for a user, may result in lost work, and/or may result in storage errors.

Some examples of the techniques described herein may reduce or eliminate disruption due to updating power delivery controller instructions. For instance, power delivery controller instructions may be updated after a computing device is shut down. Updating the power delivery controller instructions after shutdown may improve device performance and/or reduce disruption.

Throughout the drawings, identical reference numbers may designate similar, but not necessarily identical, elements. Similar numbers may indicate similar elements. When an element is referred to without a reference number, this may refer to the element generally, without necessary limitation to any particular drawing or figure. The drawings are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

FIG. 1 is a flow diagram illustrating an example of a method 100 for updating a power delivery controller. The method 100 and/or a method 100 element or elements may be performed by an apparatus (e.g., electronic device, computing device, game console, smart appliance, etc.). For example, the method 100 may be performed by the apparatus 302 described in connection with FIG. 3.

The apparatus may store 102 power delivery controller instructions in interface memory. Interface memory is memory accessible by an interface. Examples of interface memory may include Read-Only Memory (ROM), Electrically Erasable Programmable Read-Only Memory (EEPROM), flash memory, etc. An apparatus may include an interface or interfaces. An interface may be utilized to interface with a device that is external to the apparatus and/or to a device that is internal to the apparatus. Examples of interfaces include a serial peripheral interface (SPI), an inter-integrated circuit (I2C) interface, and a USB interface (e.g., USB-C interface).

An internal interface may be an interface between internal components. In some examples, an internal interface may enable communication between internal components. An SPI and an I2C interface may be examples of internal interfaces. In some examples, an internal interface may be an interface between an embedded controller, a processor (e.g., system processor), and/or interface memory. For instance, an internal interface may connect and/or interface between an embedded controller and a processor controller (e.g., a platform controller hub) to enable the embedded controller to communicate with the processor controller and/or processor. In some examples, the interface memory may be internal to an apparatus (e.g., device, host, etc.) that is connected to the interface. For instance, an internal interface may internally connect the interface memory with a component or components of the apparatus. In some examples, the interface memory may be memory on another device or component (e.g., separate third device or component) that is accessible through the interface.

A processor controller is circuitry that controls data paths and/or support operations for the processor. In some examples, the interface memory may be accessible (e.g., shared) by multiple components. For instance, the interface memory may be accessible to an embedded controller, processor controller, and/or processor (e.g., system processor). In some examples, the interface memory may be included in the interface or may not be included in the interface (e.g., the interface memory may be connected to the interface and not included in the interface).

In some examples, the apparatus may store 102 the power delivery controller instructions in the interface memory to enable accessing the power delivery controller instructions when the apparatus is shut down. In some examples, interface memory may be accessible when the apparatus is shut down, while apparatus memory (e.g., system memory) and/or storage (e.g., system storage) may not be accessible when the apparatus is shut down. In some examples, the power delivery controller instructions may be accessed in interface memory using an interface that is distinct from an interface to be updated. For instance, an embedded controller may use a first interface (e.g., SPI interface) to access the power delivery controller instructions in interface memory to update a second interface, where the first interface is distinct from the second interface (e.g., USB-C interface) that has a power delivery controller to be updated. In some examples, the second interface may be included in the apparatus or may be included in another device (e.g., a docking device).

In some examples, the apparatus may request and/or receive the power delivery controller instructions from another device. For instance, the apparatus may request and/or receive the power delivery controller instructions from a remote device (e.g., server) over a network (e.g., a local area network (LAN), wide area network (WAN), the Internet, etc.). In some examples, the apparatus may request and/or receive the power delivery controller instructions from removable storage (e.g., thumb drive, external hard drive, optical disc, etc.). In some examples, the apparatus may load and/or store 102 the power delivery controller instructions in interface memory from memory (e.g., system memory) and/or storage (e.g., system storage). In some examples, the apparatus may request and/or receive the power delivery controller instructions in response to an input. For example, the apparatus may receive an input from a user indicating a command to update an interface and/or power delivery controller instructions.

The apparatus may update 104 a power delivery controller using the power delivery controller instructions from interface memory in response to an apparatus shutdown. An apparatus may have limited functionality in a shutdown state. For example, after an apparatus is shut down, an element or elements of the apparatus may be deactivated and/or may not be provided power. For instance, apparatus memory (e.g., system memory), apparatus storage (e.g., system storage), and/or an apparatus processor may be deactivated. After an apparatus is shut down, an interface or interfaces of the apparatus may be active and/or powered. For instance, an interface or interfaces may be enabled to perform an operation or operations when the apparatus is in a shutdown state.

In some examples, updating 104 the power delivery controller may include sending the power delivery controller instructions to the power delivery controller. For instance, the apparatus may send the power delivery controller instructions from the interface memory to a power delivery controller of a docking device when the apparatus is in a shutdown state.

A docking device is a device capable of connecting to the apparatus. For example, the docking device may be connected to the apparatus via an interface or interfaces, cable or cables, plug or plugs, and/or connector or connectors. For instance, the docking device may be connected to the apparatus via an interface (e.g., USB-C interface). Examples of docking devices include power adapters, wall outlets, docking stations, port hubs, port replicators, power banks, power bricks, etc., that provide power delivery. A docking device may include a power delivery controller, which may be referred to as a docking device power delivery controller. Updating a docking device power delivery controller may include sending the power delivery controller instructions to the docking device power delivery controller.

In some examples, the apparatus may send the power delivery controller instructions from the interface memory to the power delivery controller using an element or elements of the apparatus. For example, the apparatus may include an embedded controller and/or a host power delivery controller. In some examples, the embedded controller and the host power delivery controller may be elements of an interface of the apparatus. An embedded controller is circuitry that controls a function or functions of an interface. A host power delivery controller is a power delivery controller of the apparatus.

In some examples, the embedded controller may access the power delivery controller instructions in the interface memory in response to the apparatus shutdown. For example, the embedded controller may read the power delivery controller instructions from the interface memory when the apparatus is in a shutdown state. The embedded controller may load the power delivery controller instructions into memory or storage of the embedded controller. For example, the embedded controller may include or have access to memory or storage (e.g., memory cells, registers, flash memory, private ROM, etc.), into which the embedded controller may load the power delivery controller instructions from the interface memory.

The embedded controller may send the power delivery controller instructions to the host power delivery controller. The host power delivery controller may load the power delivery controller instructions into memory or storage of the host power delivery controller. For example, the host power delivery controller may include or have access to memory or storage (e.g., memory cells, registers, flash memory, etc.), into which the host power delivery controller may load the power delivery controller instructions from the embedded controller.

The host power delivery controller may send the power delivery controller instructions to the docking device power delivery controller. The docking device power delivery controller may load the power delivery controller instructions into memory or storage of the docking device power delivery controller. For example, the docking device power delivery controller may include or have access to memory or storage (e.g., memory cells, registers, flash memory, etc.), into which the docking device power delivery controller may load the power delivery controller instructions from the host power delivery controller. The docking device power delivery controller may install the power delivery controller instructions. Installing the power delivery controller instructions may include overwriting previous power delivery controller instructions, flashing Read-Only Memory (ROM), storing the power delivery controller instructions for execution, etc.

In some examples, updating the power delivery controller instructions may include sending a command to install the power delivery controller instructions. For example, the apparatus may send a command to install the power delivery controller instructions to the docking device power delivery controller. In some examples, the embedded controller may send the command to install the power delivery controller instructions to the host power delivery controller, which may send the command to the docking device power delivery controller.

FIG. 2 is a flow diagram illustrating an example of a method 200 for updating a power delivery controller. The method 200 and/or a method 200 element or elements may be performed by an apparatus (e.g., electronic device, computing device, game console, smart appliance, etc.). For example, the method 200 may be performed by the apparatus 302 described in connection with FIG. 3. In some examples, the method 200 or element(s) thereof described in connection with FIG. 2 may be an example of the method 100 or element(s) thereof described in connection with FIG. 1. In some examples, an element or elements of the method 200 may be omitted or combined.

The apparatus may store 202 power delivery controller instructions in interface memory. This may be accomplished as described in relation to FIG. 1. For instance, the apparatus may request and/or receive (e.g., download) the power delivery controller instructions, and store 202 the power delivery controller instructions in interface memory. In some examples, storing 202 the power delivery controller instructions may be performed in response to receiving a user input from an input device (e.g., mouse, touch screen, controller, microphone, camera, etc.) included in the apparatus or linked to the apparatus.

In some examples, the interface memory may be connected to and/or accessible to an SPI. An SPI is circuitry to interface with a device or devices. For example, an SPI may communicate using four wires. The four wires may respectively carry four logic signals: SCLK (a serial clock signal provided by a master interface), MISO (master-in-slave-out, which provides signals from a slave interface to the master interface), MOSI (master-out-slave-in, which provides signaling from the master interface to the slave interface), and SS (slave select, which is provided by the master interface and indicates a selection of a slave interface). In some examples, the SPI may be an internal interface between the embedded controller, the interface memory, and/or the processor (e.g., processor controller, platform controller hub, etc.). In some examples, the interface memory may be nonvolatile memory and/or ROM that can be written to or flashed. The interface memory may be connected to and/or accessible to an interface in the apparatus or host. The power controller delivery instructions may be stored 202 in the interface memory when the apparatus is in an active state (e.g., not shut down).

The apparatus may determine 204 whether the apparatus is shut down. In some examples, determining 204 whether the apparatus is shut down may be performed by an embedded controller. For example, the embedded controller may check a state of the apparatus (e.g., processor, memory, motherboard, storage, etc.) to determine 204 whether the apparatus is shut down. In some examples, the embedded controller may determine 204 whether the apparatus is shut down by detecting power good signal behavior, which may indicate whether the apparatus (e.g., processor) is active. In some examples, the embedded controller may determine 204 whether the apparatus is shut down based on an apparatus notification. For example, the apparatus may notify the embedded controller of the shutdown via an interface (e.g., scalable memory interconnect interface) before shutdown. In a case that the apparatus is not shut down (or in a case that the apparatus is in an active state), operation may return to determine 204 whether the apparatus is shut down at a later time. In some examples, the apparatus may be shut down in response to a user input received by an input device.

In a case that the apparatus is shut down, the apparatus may load 206 the power delivery controller instructions to an embedded controller. In some examples, loading 206 the power delivery controller instructions to the embedded controller may be accomplished as described in relation to FIG. 1. For example, the embedded controller may load the power delivery controller instructions from the SPI. The embedded controller may access the SPI while the apparatus is in a shutdown state. For example, the embedded controller may load 206 the power delivery controller instructions after the apparatus is shut down.

The apparatus may send 208 an information request to a docking device power delivery controller. The information request is data that indicates a request for a type or types of information. The information request may be formatted as a digital binary code. In some examples, the information request may be sent from the embedded controller and/or the host power delivery controller. For instance, the embedded controller may send the information request to the host power delivery controller, which may in turn send the information request to the docking device power delivery controller. In some examples, the information request may be sent from the host power delivery controller without the embedded controller.

In some examples, the information request may indicate a request for a device identifier and/or a request for a power delivery controller instructions version. A device identifier is information that identifies a device. For example, the apparatus may send an information request that indicates a request for a device identifier that identifies the docking device power delivery controller and/or the docking device. A power delivery controller instructions version is information indicating a version of the power delivery controller instructions. For example, the apparatus may send an information request that indicates a request for a power delivery controller instructions version that indicates a version of the power delivery controller instructions that are stored on the docking device power delivery controller. In some examples, the information request may include multiple information requests and/or messages.

In some examples, the embedded controller, host power delivery controller, and/or docking device power delivery controller may communicate using vendor defined messages (VDMs). VDMs are messages that can be flexibly defined to carry a target type of payload data. For example, a VDM may be defined to carry the power controller interface instructions. A VDM or VDMs may be defined to indicate an information request or requests (for a device identifier and/or power delivery controller instructions version, for instance). A VDM may be defined to indicate information (e.g., the device identifier and/or the power delivery controller instructions version). In some examples, a VDM may include a header with a number of bits (e.g., 14 bits) and a field or fields with a number of bits (e.g., up to six fields of 32 bits each). In some examples, the apparatus may send 208 the information request to the docking device power delivery controller as a VDM or VDMs.

The apparatus may receive 210 information from the docking device power delivery controller. The information may be formatted as a digital binary code or codes. For example, the docking device power delivery controller may send information to the apparatus. In some examples, the information received 210 may include and/or indicate a device identifier and/or a power delivery controller instructions version.

The apparatus may determine 212 whether to proceed with an update. In some examples, the apparatus may determine 212 whether to proceed with the update based on the received 210 information. For example, the apparatus may determine whether the device identifier indicates compatibility with the power delivery controller instructions. For instance, the embedded controller may compare the device identifier with the power delivery controller instructions (e.g., the loaded power delivery controller instructions). The device identifier may indicate compatibility in a case that the device identifier matches (e.g., is the same as) a device indicator or a device category indicated by the power delivery controller instructions. In some examples, the apparatus may determine 212 whether to proceed based on whether a version of the power delivery controller instructions (e.g., a version indicated by the power delivery controller instructions loaded to the embedded controller) is later than (e.g., is a newer version than) the power delivery controller instructions version from the docking device power delivery controller (e.g., the version indicated by the received information).

Determining 212 whether to proceed with the update may be based on a criterion or criteria. For example, the determination 212 may be based on whether the device identifier indicates compatibility, based on whether the version of the power delivery controller instructions (on the apparatus or host) is later than the power delivery controller version (on the docking device), or both. For instance, the apparatus (e.g., embedded controller) may determine to proceed with the update in a case that the device identifier indicates compatibility and in a case that the version of the power delivery controller instructions (on the apparatus or host) is later than the power delivery controller instructions version from the docking device power delivery controller. Otherwise, the apparatus may determine to not proceed with the update.

In a case that the apparatus determines to not proceed with the update (e.g., the criterion is or criteria are not met), operation may end 214. For example, the power delivery controller instructions may not be updated if the device identifier is different or if the version of the power delivery controller instructions in the interface memory is the same as or older than the power delivery controller instructions stored on the docking device power delivery controller.

In a case that the apparatus determines to proceed with the update (e.g., the criterion is or the criteria are met), the apparatus may update the docking device power delivery controller. In some examples, the apparatus may send 216 the power delivery controller instructions to a host power delivery controller. For example, the embedded controller may send 216 the power delivery controller instructions to a host power delivery controller. In some examples, the power delivery controller instructions may be sent to the host power delivery controller using a message or messages (e.g., VDM or VDMs).

The apparatus may send 218 the power delivery controller instructions to the docking device power delivery controller. For example, the power delivery controller instructions may be sent 218 to the docking device power delivery controller from the host power delivery controller. In some examples, the power delivery controller instructions may be sent to the docking device power delivery controller using a message or messages (e.g., VDM or VDMs). In some examples, the apparatus (e.g., the embedded controller and/or the host power delivery controller) may send a command to install the power delivery controller instructions to the docking device power delivery controller.

In some examples, the docking device power delivery controller may install the power delivery controller instructions or code upon receiving the power delivery controller instructions and the command from the host power delivery controller. In some examples, docking device power delivery controller may disconnect a power source from the apparatus during installation of the power delivery controller instructions. The docking device power delivery controller may provide power to the apparatus after installing the power delivery controller instructions. Because the docking device power delivery controller instructions are installed when the apparatus is in a shutdown state, the update and/or installation may not disrupt a user of the apparatus, which may be beneficial.

Some of the techniques describes herein may be beneficial for various reasons. For example, a user may continue to use an apparatus and/or docking device until shutdown and may avoid being impacted by docking device power delivery controller instruction installation. For instance, the embedded controller may start the update for the docking device power delivery controller after apparatus shutdown, which can prevent the apparatus from shutting down during docking device power delivery controller instruction installation, thereby improving user experience. In some examples, the apparatus may detect a docking device and/or may detect a docking device power delivery controller instruction version via a message or messages (e.g., VDM(s)). The power delivery controller instructions may be updated automatically when the docking device is connected and the apparatus is shutdown.

FIG. 3 is a block diagram of an example of an apparatus 302 that may be used in updating a power delivery controller. The apparatus 302 may be an electronic device, such as a personal computer, a desktop computer, a game console, a smart appliance, etc. The apparatus 302 may include and/or may be coupled to a processor 304, a memory 306, interface memory 312, a serial peripheral interface (SPI) 324, an embedded controller 316, and/or a host power delivery controller 318. In some examples, the embedded controller 316 may include or have access to memory or storage (e.g., that may be separate from the system memory 306 and/or separate from the interface memory 312). In some examples, the host power delivery controller 318 may include memory or storage (e.g., that may be separate from the system memory 306). The apparatus 302 may include additional components (not shown) and/or some of the components described herein may be removed and/or modified without departing from the scope of this disclosure.

In some examples, the embedded controller 316 may communicate with the interface memory 312 and/or processor 304 with the SPI 324. For instance, the embedded controller 316 may access the interface memory 312 by an SPI 324 bus. In some examples, the host power delivery controller 318 and the embedded controller 316 may communicate using an I2C interface. In some examples, the host power delivery controller 318 and the docking device power delivery controller 310 may communicate using a USB (e.g., USB-C) interface. For instance, the host power delivery controller 318 and the docking device power delivery controller 310 may communicate by a Configuration Channel (CC) of a USB-C interface. In some examples, the host power delivery controller 318 may not communicate directly with the processor 304 and/or the memory 306. For instance, the host power delivery controller 318 may communicate with the embedded controller 316 by an I2C interface. In some examples, the embedded controller 316 may communicate with the processor 304 (e.g., processor controller) via the SPI 324. While examples of interfaces are described herein, other types of interfaces may be included in the apparatus 302 and/or utilized in some instances (e.g., an enhanced SPI may be utilized between the embedded controller and a processor controller). Communicating may include sending and/or receiving signals (e.g., electronic signals, waveforms, etc.) and/or data. For instance, instructions, data, information, requests, responses, etc., may be communicated over an interface or interfaces.

The processor 304 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. In some examples, the processor 304 may include multiple processors (e.g., a CPU and a GPU). The processor 304 may fetch, decode, and/or execute instructions stored in the memory 306. In some examples, the processor 304 may include an electronic circuit or circuits that include electronic components for performing a function or functions of the instructions. In some examples, the processor 304 and/or memory 306 may be shut down during performance of some of the functions, operations, elements, etc., described in connection with one, some, or all of FIGS. 1-4.

The memory 306 may be any electronic, magnetic, optical, or other physical storage device that contains or stores electronic information (e.g., instructions and/or data). The memory 306 may be, for example, Random Access Memory (RAM), Electrically Erasable Programmable Read-Only Memory (EEPROM), a storage device, an optical disc, and/or the like. In some examples, the memory 306 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some implementations, the memory 306 may be a non-transitory tangible machine-readable storage medium, where the term “non-transitory” does not encompass transitory propagating signals. In some examples, the memory 306 may include multiple devices (e.g., a RAM card and a solid-state drive (SSD)).

In some examples, the embedded controller 316 and the host power delivery controller 318 may be included in a communication interface. An example of the communication interface may be a USB (e.g., USB-C) interface. The communication interface may enable the apparatus 302 to communicate with an external device or devices (e.g., docking device 308). In some examples, the apparatus 302 may be in communication with (e.g., coupled to, have a communication link with) a docking device 308 via the communication interface. For example, the apparatus 302 may be connected to the docking device 308 with a cable or cables (e.g., USB cable(s)). Examples of the docking device 308 may include power adapters, wall outlets, docking stations, port hubs, port replicators, power banks, power bricks, etc., that provide power delivery. The docking device 308 may provide electrical power to the apparatus from a power source 360. Examples of power sources 360 may include a power grid (e.g., wall outlet), solar panel, generator, external battery, etc. The docking device 308 may include a docking device power delivery controller 310.

In some examples, the apparatus 302 may include hardware and/or machine-readable instructions to enable the processor 304 to communicate with an external device or devices (e.g., input devices, network devices, etc.). For instance, the apparatus 302 may have a wired and/or wireless connection to the external device or devices. In some examples, the apparatus may include a network interface card. For instance, the apparatus may link to a network or networks, such as a local area network (LAN), wide area network (WAN), the Internet, cellular network, Long Term Evolution (LTE) network, 5G network, etc. In some examples, the apparatus 302 may download power delivery controller instructions 314 from a network, which may be stored in interface memory 312 that is connected to and/or accessible via the SPI 324. In some examples, the power delivery controller instructions 314 may be referred to as power delivery code.

In some examples, the apparatus may include hardware and/or machine-readable instructions to enable the processor 304 to communicate with various input and/or output devices, such as a keyboard, a mouse, a display, another apparatus, electronic device, computing device, etc., through which a user may input instructions and/or data into the apparatus 302. In some examples, the memory 306 of the apparatus 302 may store instructions (e.g., programs) for performing various functions on the apparatus.

In some examples, the SPI 324, the embedded controller 316, and/or the host power delivery controller 318 may perform an operation or operations described in relation to FIG. 1, FIG. 2, and/or FIG. 4. For example, the SPI 324 may store power delivery controller instructions 314 in interface memory 312. The embedded controller 316 may load the power delivery controller instructions 314 and determine whether to proceed with an update in response to detecting a shutdown of the apparatus 302. In some examples, the host power delivery controller 318 may request a device identifier and/or a power delivery controller instructions version from the docking device power delivery controller 310. The host power delivery controller 318 may receive the device identifier and/or the power delivery controller instructions version from the docking device power delivery controller 310. For instance, the docking device power delivery controller 310 may include docking device power delivery controller memory and/or storage 322. The docking device power delivery controller memory and/or storage 322 may include the device identifier and/or the power delivery controller instructions version. The docking device power delivery controller 310 may send the device identifier and/or the power delivery controller instructions version in response to receiving the request(s) from the host power delivery controller 318. For instance, the docking device power delivery controller 310 may send a device identifier and a power delivery code version in response to a request from the host power delivery controller 318 when a computing device that includes the host power delivery controller 318 is shut down. The host power delivery controller 318 may provide the device identifier and/or the power delivery controller instructions version to the embedded controller 316.

In some examples, the embedded controller 316 may determine to proceed with the update in a case that the device identifier matches a device identifier associated with the power delivery controller instructions 314 and in a case that the power delivery controller instructions version from the docking device power delivery controller 310 is outdated by a version of the power delivery controller instructions 314. In response to the embedded controller 316 determining to proceed with the update, the host power delivery controller 318 may send the power delivery controller instructions 314 to the docking device power delivery controller 310.

In some examples, the docking device power delivery controller 310 may install the power delivery controller instructions 314 from the host power delivery controller 318 when the apparatus 302 is shut down. For instance, the docking device power delivery controller 310 may install power delivery code from the host power delivery controller 318 when a computing device that includes the host power delivery controller 318 is shut down. For instance, the docking device power delivery controller 310 may replace a power delivery code of the power delivery code version with the power delivery code of a later version.

FIG. 4 is a thread diagram illustrating an example of updating a power delivery controller. FIG. 4 illustrates an SPI 424, an embedded controller 416, a host power delivery controller 418, and a docking device power delivery controller 410. The SPI 424, the embedded controller 416, the host power delivery controller 418, and/or the docking device power delivery controller 410 may be examples of corresponding devices described in relation to FIG. 1, FIG. 2, and/or FIG. 3.

The serial peripheral interface 424 may store 401 power delivery code. The embedded controller 416 may detect 403 a shutdown of an apparatus (e.g., computer) in which the embedded controller 416 is included.

In response to the detected shutdown, the embedded controller 416 may load 405 power delivery code from the SPI 424 (e.g., SPI memory). The embedded controller may send 407 a request for a device identifier and a power delivery code version to the host power delivery controller 418. The host power delivery controller 418 may send 409 the request for the device identifier and the power delivery code version to the docking device power delivery controller 410. For instance, the host power delivery controller 418 may send 409 the request via USB-C.

The docking device power delivery controller 410 may send 411 the device identifier and the power delivery code version to the host power delivery controller 418. The host power delivery controller 418 may send 413 the device identifier and the code version to the embedded controller 416. The embedded controller 416 may determine 415 to update the docking device power delivery controller. For instance, the embedded controller 416 may determine that the device identifier matches a device corresponding to the power delivery code and that the power delivery code version stored in the SPI 424 is a newer version than the power delivery code version stored on the docking device power delivery controller 410.

The embedded controller 416 may send 417 the power delivery code to the host power delivery controller 418. The host power delivery controller 418 may send 419 the power delivery code to the docking device power delivery controller 410. The docking device power delivery controller 410 may install 421 the power delivery code.

While various examples of systems and methods are described herein, the systems and methods are not limited to the examples. Variations of the examples described herein may be implemented within the scope of the disclosure. For example, operations, functions, aspects, or elements of the examples described herein may be reordered, omitted, and/or combined.

1. A method, comprising:
updating, when an apparatus processor and memory are inactive, a power delivery controller using power delivery controller instructions from interface memory in response to an apparatus shutdown.

2. The method of claim 1, further comprising accessing the power delivery controller instructions in the interface memory in response to the apparatus shutdown.

3. The method of claim 1, further comprising storing the power delivery controller instructions in the interface memory.

4. The method of claim 1, further comprising loading the power delivery controller instructions to an embedded controller.

5. The method of claim 1, further comprising sending, from a host power delivery controller, an information request to the power delivery controller, wherein the power delivery controller is a docking device power delivery controller.

6. The method of claim 5, further comprising receiving information from the docking device power delivery controller.

7. The method of claim 6, wherein the information comprises a device identifier and a power delivery controller instructions version.

8. The method of claim 7, wherein updating the docking device power delivery controller is performed in response to determining that the device identifier indicates compatibility with the power delivery controller instructions and in response to determining that a version of the power delivery controller instructions is later than the power delivery controller instructions version from the docking device power delivery controller.

9. The method of claim 1, wherein updating the power delivery controller comprises sending the power delivery controller instructions to the power delivery controller from a host power delivery controller.

10. The method of claim 1, wherein updating the power delivery controller comprises sending a command to install the power delivery controller instructions.

11. An apparatus, comprising:
serial peripheral interface circuitry to store power delivery controller instructions in serial peripheral interface memory;
embedded controller circuitry to load, when an apparatus processor and memory are inactive, the power delivery controller instructions and to determine whether to proceed with an update in response to detecting a shutdown of the apparatus; and
host power delivery controller circuitry to send the power delivery controller instructions to a docking device power delivery controller on a separate docking device in response to the embedded controller determining to proceed with the update.

12. The apparatus of claim 11, wherein the host power delivery controller circuitry is to request a device identifier and a power delivery controller instructions version from the docking device power delivery controller.

13. The apparatus of claim 12, wherein the embedded controller circuitry is to determine to proceed with the update in a case that the device identifier matches a second device identifier associated with the power delivery controller instructions and in a case that the power delivery controller instructions version from the docking device power delivery controller is outdated by a version of the power delivery controller instructions.

14. A docking device, comprising:
docking device power delivery controller circuitry to send a device identifier and a power delivery code version in response to a request from a host power delivery controller, and to install power delivery code from the host power delivery controller when a computing device that includes the host power delivery controller is shut down and when a computing device processor and memory are inactive.

15. The docking device of claim 14, wherein the docking device power delivery controller circuitry is to replace a second power delivery code of the power delivery code version with the power delivery code of a later version.
